(19) United States
(12) Patent Application Publication
(10) Pub. No.: US 2016/0319950 A1
(43) Pub. Date: Nov. 3, 2016

(54) ROTARY FLUID REGULATOR

(71) Applicant: Dr. Ing. h.c. F. Porsche Aktiengesellschaft, Stuttgart (DE)

(72) Inventors: Thomas Geffert, Freiberg am Neckar (DE); Frank Blum, Siegelsbach (DE)

(21) Appl. No.: 15/132,422

(22) Filed: Apr. 19, 2016

(30) Foreign Application Priority Data
Apr. 29, 2015 (DE) 10 2015 106 672.6

(51) Int. Cl. F16K 31/04; F16K 31/12

(52) U.S. Cl. CPC F16K 31/041; F16K 31/12

(57) ABSTRACT

A rotary fluid regulator (1, 300) has a housing (2) with at least one inlet opening (3, 4) and at least one outlet opening (5). A valve element (7, 100) is received rotatably in the housing (2) and is a hollow fluid duct (8). A drive element (19, 301, 401, 501) is provided to rotate the valve element (7, 100) so that a fluidic connection between the at least one inlet opening (3, 4) and the at least one outlet opening (5) can be adjusted or blocked. A brake element is provided for influencing or blocking the movement of the valve element.

### CROSS REFERENCE TO RELATED APPLICATION

This application claims priority under 35 USC 119 to German Patent Appl. No. 10 2015 106 672.6 filed on Apr. 29, 2015, the entire disclosure of which is incorporated herein by reference.

### BACKGROUND

1. Field of the Invention

The invention relates to a rotary fluid regulator, in particular a rotary fluid regulator for controlling a fluid flow in a motor vehicle.

2. Description of the Related Art

Rotary fluid regulators are known in the prior art. For example, DE 10 2011 120 798 A1 discloses a rotary fluid regulator with a housing and a rotary disk with openings is received rotatably in the housing. Fluid flow is led through the openings perpendicular to the plane of the rotary disk so that a diversion of the fluid through 180° is performed within the housing with an adverse effect on the pressure drop.

DE 100 53 850 A1 discloses a rotary fluid regulator in the form of an eccentric valve with at least one pivotable plate that can be placed in contact with a valve seat. The disk pivots from the valve seat to control a fluid flow through an outlet opening. The pressure drop is still very considerable due to the position of the disk during the opening of the valve.

It is the object of the invention to provide a rotary fluid regulator that is of simple construction, but nevertheless permits good adjustability or regulation of fluid flows with a small pressure drop. A reliable and energy-saving setting of an intermediate position should also be possible.

### SUMMARY

The invention relates to a rotary fluid regulator having a housing with at least one inlet opening, at least one outlet opening, and a valve element that is received rotatably in the housing. The valve element is of hollow form and forms a fluid duct. A drive element is provided for rotating the valve element. Rotation of the hollow valve element can adjust or block a fluidic connection between the at least one inlet opening and the at least one outlet opening. A brake element is provided for influencing or blocking the movement of the valve element. In this way, the position or setting of the valve element is controlled by interaction between the control of the drive element and the control of the brake element.

Two or more outlet openings may be provided so that a fluid flow can be distributed to one and/or the other outlet opening. Thus, a fluid flow to be split up by the rotary fluid regulator in controlled fashion in accordance with the setting thereof.

Two or more inlet openings may be provided so that a fluid flow can be fed to one and/or the other outlet opening. In this way, the rotary fluid regulator is also capable of mixing different fluid flows at the inlet side, for example in order to attain a targeted temperature of the mixed fluids.

The drive element may be an electromotive drive element, such as an electric motor, and may have an output element connected by a mechanism to the valve element to rotate the drive element. In this way, a simple rotation or setting of the valve element can be performed. Thus, the electric motor can be actuated in an effective manner and can act on the control element directly or via a mechanism. The mechanism may be a speed-reduction mechanism that reduces the rotational speed of the electric motor, such that the valve element is rotated at a reduced rotational speed.

The drive element may be a hydraulic or pneumatic drive element, such as a hydraulic cylinder or vacuum capsule that has an output element connected by a mechanism to the valve element to rotate the valve element. In this way, too, a rotation of the valve element can be realized in a simple manner.

The mechanism may be a toothed-rack mechanism, a lever mechanism or a toothed-wheel mechanism. In this way, proceeding from the drive element, it is possible for the valve element to be driven in uncomplicated fashion so that the drive movement of the drive element is converted correspondingly into the movement of the valve element.

The brake element may be a magnetorheological brake element that can be actuated electronically so that a magnetic field can be applied in an electronically controllable fashion to achieve the braking action of the braking element.

The magnetorheological brake element may have an element that is received in displaceable fashion in a chamber. The chamber receives a magnetorheological material that, in a magnetized state, inhibits the displacement of the displaceable element in the chamber and, in the non-magnetized state, substantially does not inhibit the displacement of the displaceable element. The magnetized state is a state in which an externally applied magnetic field causes elements of the magnetorheological material to be interlinked and to exhibit an increased viscosity.

The displaceable element may be piston or slide that is longitudinally displaceable in the chamber. In this way, it is possible to utilize a targeted change in the viscosity of the magnetorheological material to influence the valve element.

In another embodiment, the displaceable element may be a rotary piston or rotary slide that is received in rotationally displaceable fashion in the chamber.

A force store element, such as a spring, may act on the drive element, on the mechanism or on the valve element so that, in the non-driven state, a force acts in the direction of a predefined position of the valve element so that the valve element is moved into the end position. Thus, in a non-driven situation, the valve element is moved into a predefined position to realize a defined functionality. Such a position may be a defined end position.

The invention will be discussed in detail below on the basis of an exemplary embodiment and with reference to the drawing.

### BRIEF DESCRIPTION OF THE DRAWINGS

FIG. 1 is an exploded illustration of a rotary fluid regulator.

FIG. 2 is an exploded illustration of the rotary fluid regulator.

FIG. 3 is an exploded perspective view of the rotary fluid regulator.

FIG. 4 is a perspective, partially sectional view of the rotary fluid regulator.

FIG. 5 is a perspective view of the rotary fluid regulator.

FIG. 6 is a perspective view of the rotary fluid regulator.

FIG. 7 is a detail of the housing of the rotary fluid regulator.

FIG. 8 is a view of the sealing element of the rotary fluid regulator.

FIG. 9 is a view of the sealing element of the rotary fluid regulator.

FIG. 10 is a sectional view of the rotary fluid regulator.

FIG. 11 is a sectional view of the rotary fluid regulator.

FIG. 12 is a sectional view of the rotary fluid regulator.

FIG. 13 is a detail of the rotary fluid regulator.

FIG. 14 is a detail of the rotary fluid regulator.

FIG. 15 is an exploded illustration of a housing cover with drive element and brake element.

FIG. 16 shows a section through the rotary fluid regulator.

FIG. 17 is a perspective view of a further exemplary embodiment of a rotary fluid regulator.

FIG. 18 shows a sectional view of a drive element with brake element

FIG. 19 shows a side view of a drive element with brake element.

FIG. 20 shows a sectional view of the drive element of FIG. 19.

### DETAILED DESCRIPTION

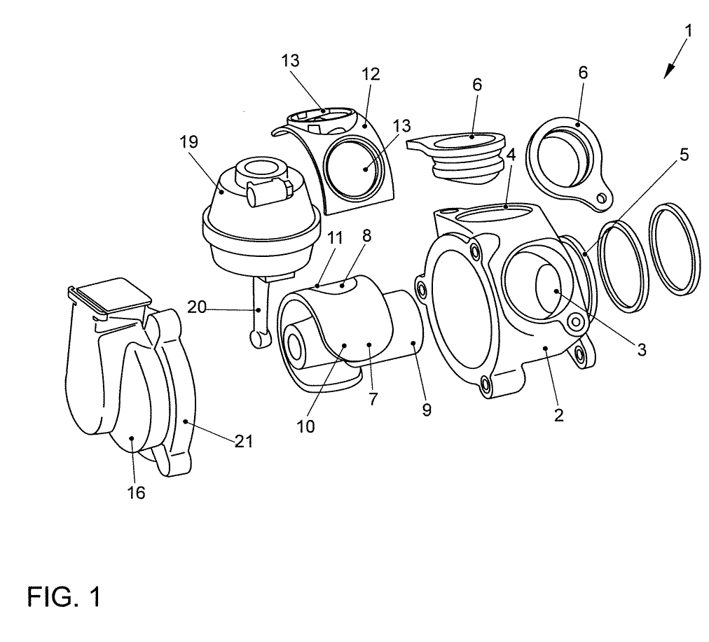

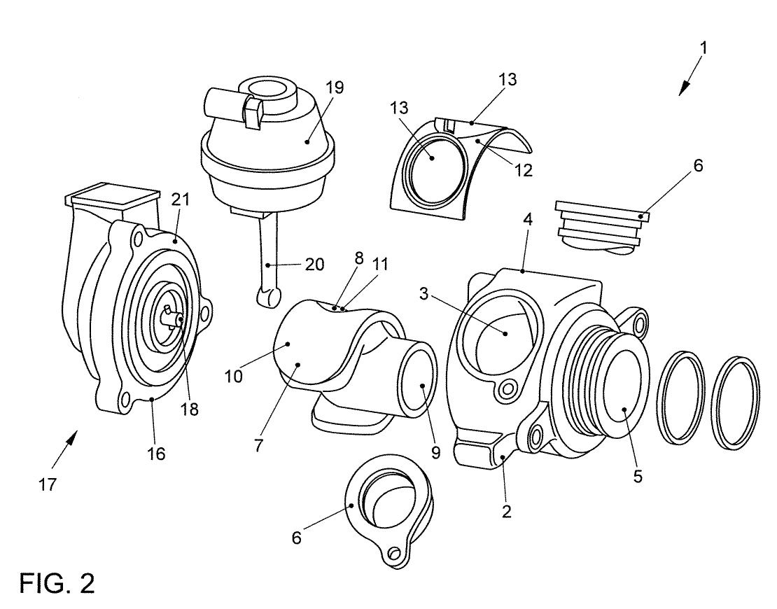

FIGS. 1 and 2 are exploded views of a rotary fluid regulator 1 from different perspectives. The rotary fluid regulator 1 has a housing 2 with at least one inlet opening 3, 4 and at least one outlet opening 5. In the embodiment of FIGS. 1 and 2, two inlet openings 3, 4 and one outlet opening 5 are provided. The inlet openings 3, 4 are on the outer circumference of the housing 2 and the outlet opening 5 is on a face wall of the housing 2.

The two inlet openings 3, 4 are equipped with connector elements 6 to permit a connection to the two inlet openings 3, 4. The connector elements engage into the inlet openings and function for connection and/or sealing-off of, for example, a supply pipe arrangement or hose arrangement.

A rotatable valve element 7 is arranged in the housing 2. The valve element 7 is hollow and forms a fluid duct 8 that extends from an axial end 9 to an opening 11 on the circumferential surface 10. The valve element 7 is arranged rotatably in the housing 2 so that it connects one and/or the other inlet opening 3, 4 to the outlet opening 5. The fluid duct 8 is formed in the valve element 7, and the opening 11 of the valve element 7 overlaps with one of the inlet openings to connect the inlet opening to the outlet opening 5.

The valve element 7 is arranged rotatably in a receptacle in the housing 2, and a sealing element 12 is provided radially between the valve element 7 and the circumferential wall of the housing 2 to seal off the valve element 7 against the housing 2. In this way, sealing of an inlet opening 3, 4 can be realized when the opening 11 is not in alignment with the respective inlet opening 3, 4.

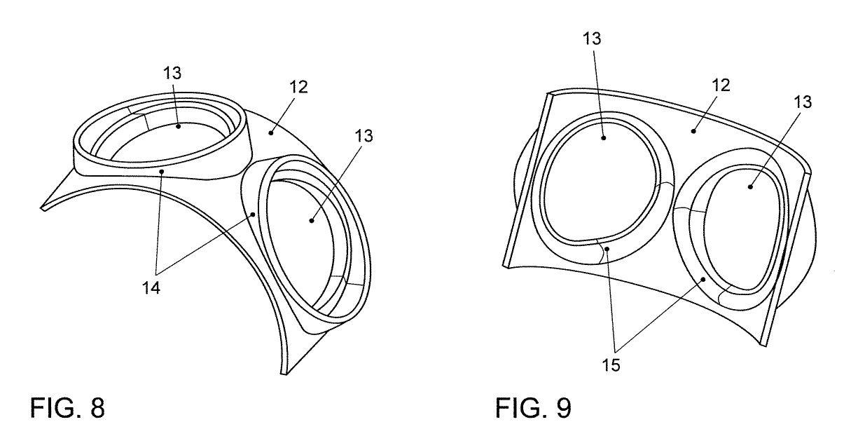

The sealing element 12 is a shallow, curved and elastic element with two openings 13 and sealing beads 14, 15 are provided on both side around the openings 13, see FIGS. 8 and 9. The sealing beads 14 engage into the inlet openings 3, 4. The sealing beads 15 seal off with respect to the valve element 7.

The housing 2 has a housing cover 16 that closes off the housing 2 and in which a drive connection 17 of the valve element 7 is arranged. A shaft 18 is provided in the housing cover 16. One end of the shaft 18 can be connected to the valve element 7 and the other end can be connected to a drive element 19. A mechanism is provided that converts the movement of the drive element 19 into a movement of the valve element 7.

In the embodiment of FIGS. 1 and 2, the drive element 19 is a vacuum capsule that has a plunger 20 as an output element. The longitudinally displaceable plunger 20 engages into a receptacle of the housing cover 16 and is connected to the mechanism and thus to the valve element 7.

A brake element 21 is integrated into the housing cover 16 in the embodiments of FIGS. 1 and 2, and is in the form of a magnetorheological brake element 21. The brake element 21 is provided for permitting controlled influencing or controlled blocking of the movement of the valve element 7.

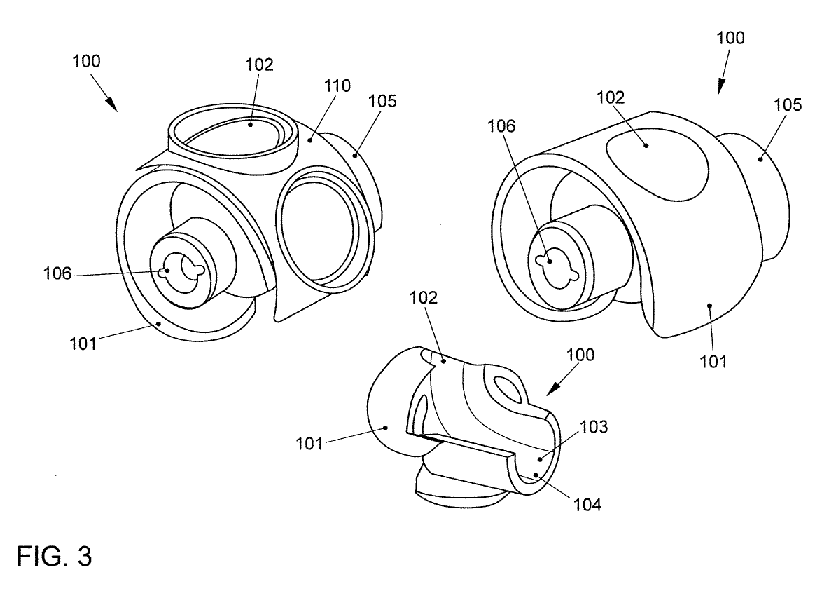

FIG. 3 shows the valve element 100 in various illustrations. The valve element has a circumferential wall 101 in which an opening 102 of the fluid duct 103 is arranged. The fluid duct 103 is arcuate and runs from the opening 104 that is provided in an axial direction to the opening 102 in the circumferential wall. A shank 105 is disposed around the opening 104 and functions for mounting the valve element 100 in the housing of the rotary fluid regulator. A bearing can engage around the shank 105 and functions to mount the valve element 100. A receiving element 106 is on the side of the valve element 100 opposite the shank 105 and can accommodate a shaft to drive or rotate the valve element. The receiving element has a transverse depression that can receive a shaft with transverse web to transmit a torque.

The sealing element 110 is radially outside the valve element 100, as shown in FIGS. 8 and 9.

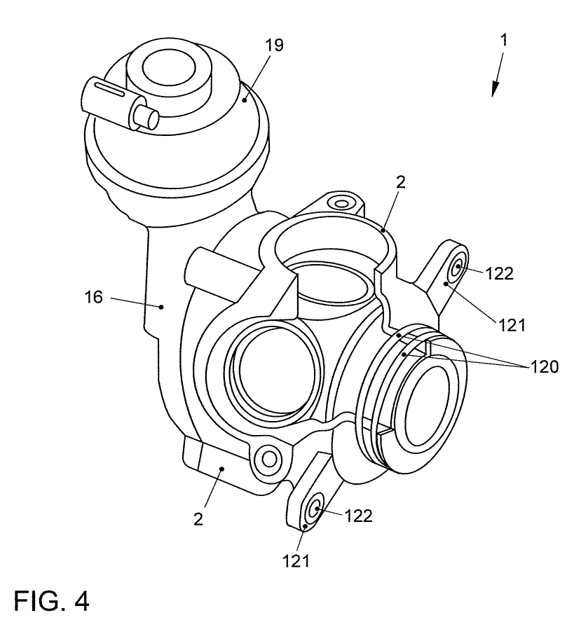

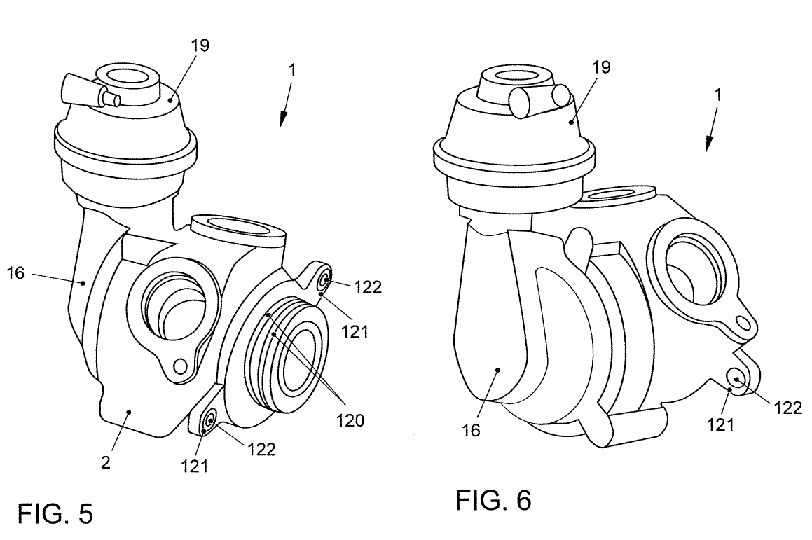

FIGS. 4 to 6 show the assembly of the rotary fluid regulator 1 from various perspectives and shows the compact structural form of the connection of the housing 2 to housing cover 16 and to the drive element 19. The output element of the drive element 19 engages into an opening or into a channel in the housing cover 16 so as to be protected against external influences. The drive element 19 is connected to the housing cover 16, which in turn is connected to the housing 2 to form a compact unit.

A ring-shaped flange is formed around the outlet opening and receives sealing rings 120 in grooves so that the rotary fluid regulator can be arranged in a receptacle. Fastening arms 121 with fastening openings 122 are arranged laterally adjacent the ring-shaped flange for fastening the rotary fluid regulator 1 to an assembly by a screw connection.

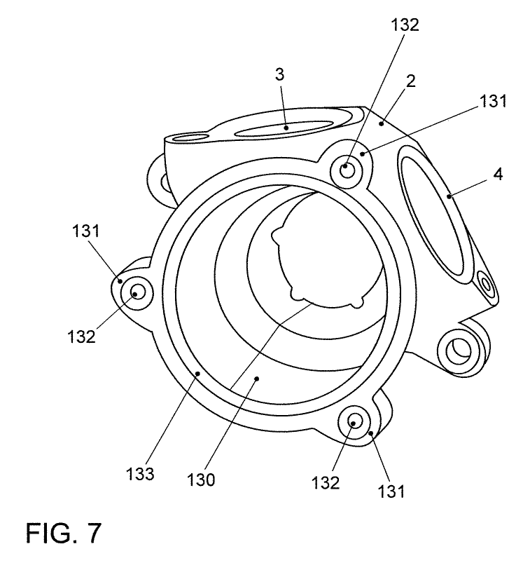

FIG. 7 shows the housing 2 from the side onto which the housing cover 16 is mounted and illustrates a circular opening 130 with an encircling edge 133 onto which the housing cover 16 can be mounted and sealed. Fastening arms 131 with connecting bores 132 are provided and receive screws for connecting the housing cover 16 to the housing 2.

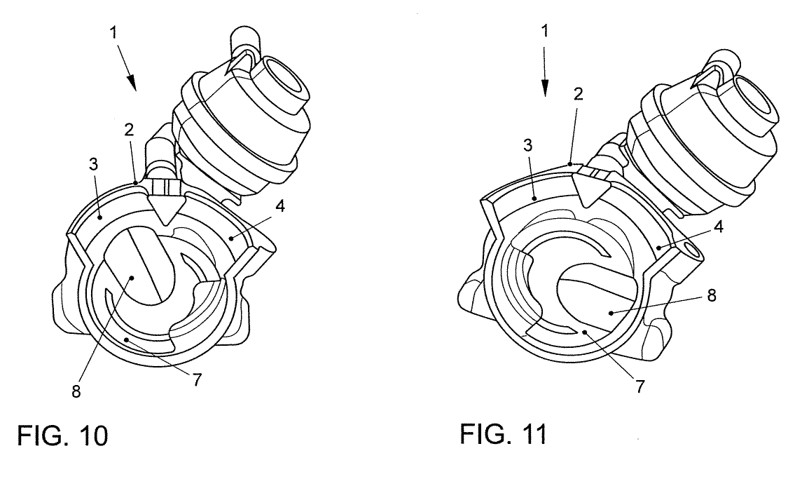

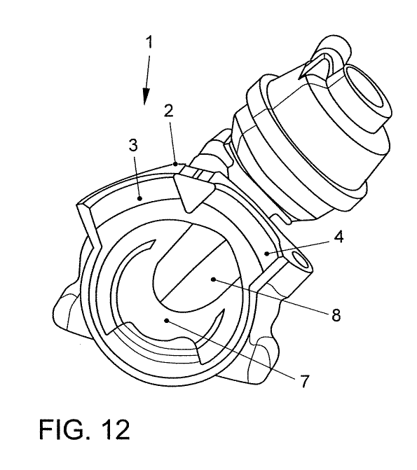

FIGS. 10 to 12 each show a section through a rotary fluid regulator 1 of the preceding figures, where the valve element 7 is shown in each case in a different setting. FIG. 10 shows the valve element 7 set in the housing 2 so that the fluid duct 8 communicates with one inlet opening 3. In this way, a fluid flow from a fluid duct connected to the inlet opening 3 can flow into the rotary fluid regulator 1. FIG. 11 shows the valve element 7 set in the housing 2 so that the fluid duct 8 communicates with neither of the two inlet openings 3, 4. In this way, a fluid flow from a fluid duct connected to the inlet opening 3 or from a fluid duct connected to the inlet opening 4 can flow into the rotary fluid regulator 1. FIG. 12 shows the valve element 7 set in the housing 2 so that the fluid duct 8 communicates with one inlet opening 4. In this way, a fluid flow from a fluid duct connected to the inlet opening 4 can flow into the rotary fluid regulator 1.

An intermediate setting is also conceivable in which the valve element 7 is set in the housing 2 so that the fluid duct 8 partially communicates with one inlet opening 3 and partially communicates with the other inlet opening 4. In this way, a fluid flow from a fluid duct connected to the inlet opening 3 and from a fluid duct connected to the inlet opening 4 can flow proportionately into the rotary fluid regulator 1.

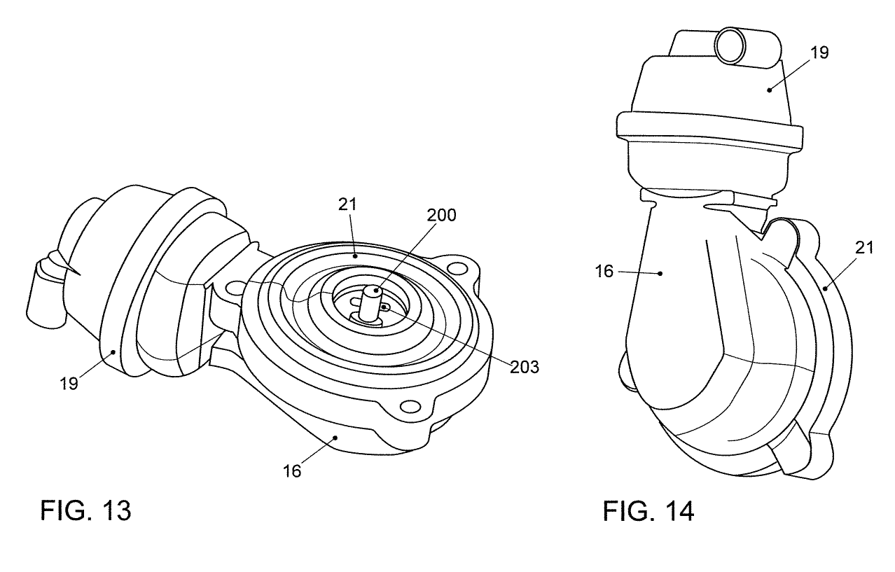

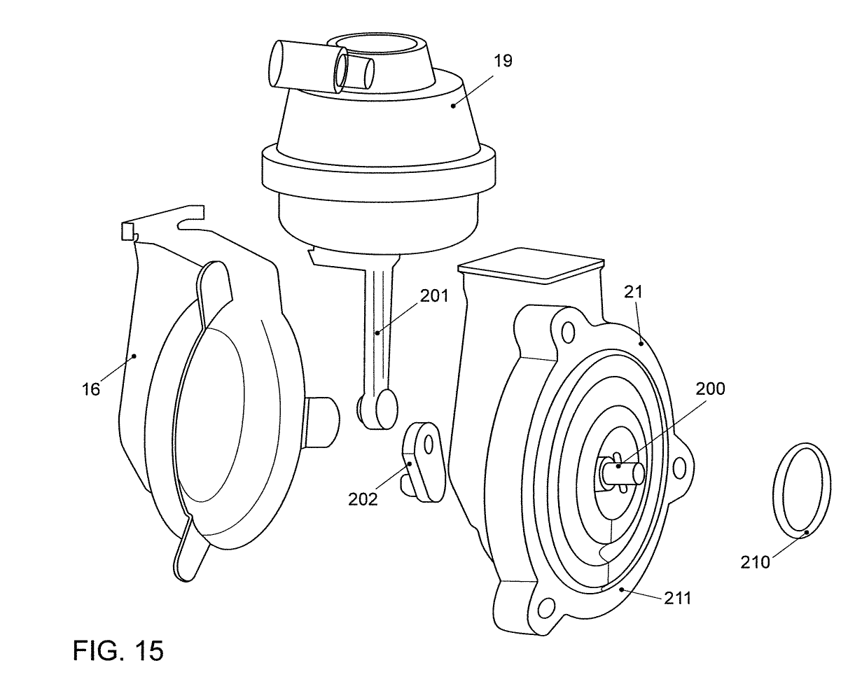

FIGS. 13 to 15 show the housing cover 16 with the drive element 19 and the brake element 21 connected thereto.

The brake element 21 is approximately cylindrical and a shaft 200 leads through the brake element 21. One end of the shaft 200 is connected in positively locking fashion to the valve element 7, whereas the other end of the shaft 200 is connected to the plunger 201 of the drive element 19 by way of a lever 202 as mechanism.

The positively locking connection of the shaft 200 to the valve element is achieved by a transverse web 203 that is connected to the shaft 200 and advantageously is led through a bore through the shaft.

The housing cover 16 covers the connection between the plunger 201 and the shaft 200. Furthermore, a sealing ring 210 seals the brake housing 211 off in the region of the shaft 200.

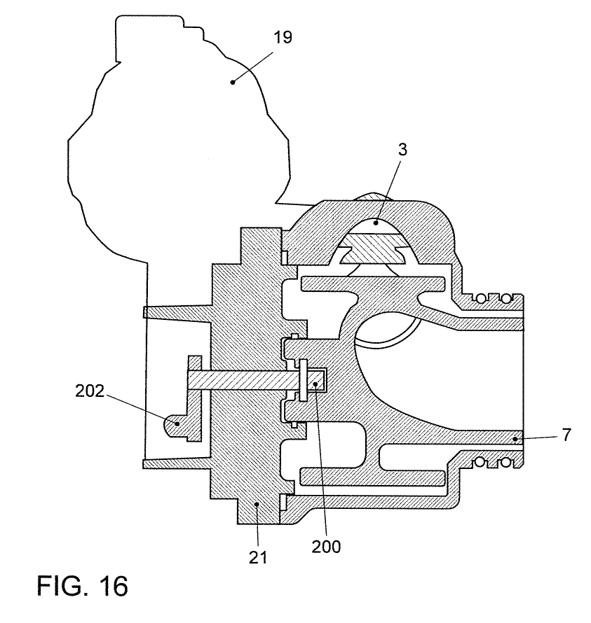

FIG. 16 shows a section through the rotary fluid regulator 1 in the longitudinal direction of the rotary fluid regulator 1. FIG. 16 shows the rotary fluid regulator 1 in a setting in which the valve element 7 blocks the inlet opening 3. At the drive side, the valve element 7 is connected by the shaft 200 and the lever 202 to the plunger 201 of the drive element 19. The shaft 200 extends through the brake element 21.

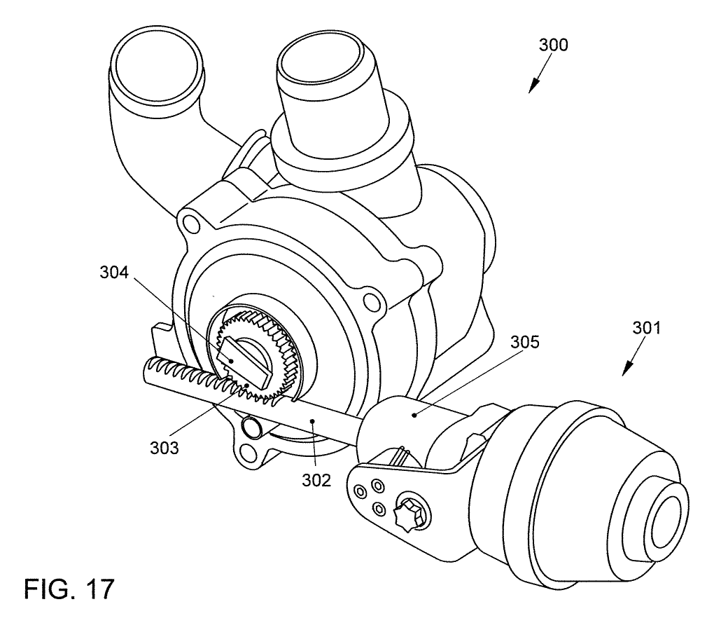

FIG. 17 shows a further embodiment of a rotary fluid regulator 300 that is similar to the rotary fluid regulator 1 of the preceding figures. The rotary fluid regulator 300 has a drive element 301 in the form of a vacuum capsule with a toothed rack 302 as plunger. The toothed rack acts on a toothed wheel 303 that is connected to the shaft 304 of the valve element. The brake element 305 is integrated into the vacuum capsule.

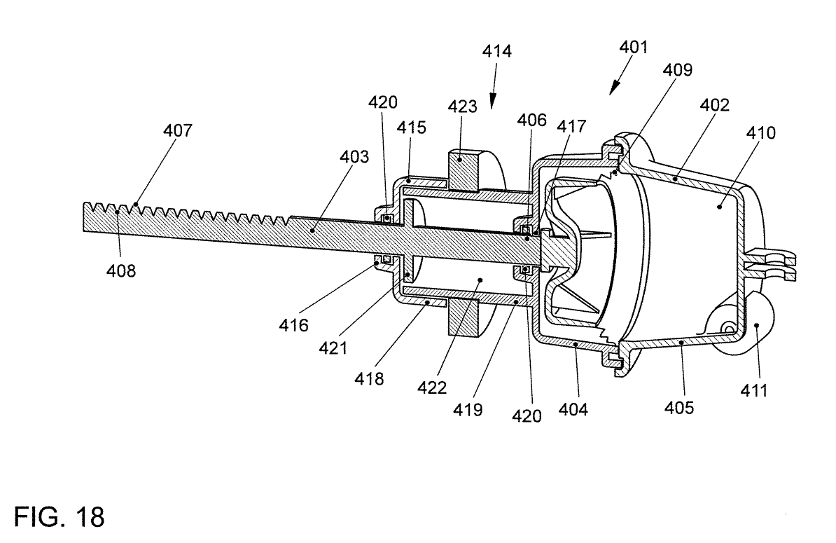

FIG. 18 is a sectional view of a further embodiment of a drive element 401 that can be used for the rotary fluid regulator of FIG. 17. The drive element 401 has a housing 402 in which a plunger 403 is guided displaceably and out of which the plunger 403 projects. The housing 402 advantageously is formed in at least two parts with at least two elements 404, 405 of the housing 402 connected to one another in sealed-off fashion to form a substantially closed capsule. The at least two elements 404, 405 may be connected to one another in sealing-off fashion, for example, by welding or adhesive bonding or the like. A seal may also be arranged in between.

The plunger 403 is in an elongate rod with a first end 406 in the housing 402 and a second end 407 led out of the housing 402. A movable element may be articulated to the second end 407 of the plunger 403 and can be actuated by the drive element 401. For this purpose, the drive element 401 has a toothing 408 on the second end 407 of the plunger 403. Alternatively, a receptacle of some other form, such as a lever may be articulated to the second end 407 of the plunger 403.

A diaphragm 409 is arranged in the housing 402 and is connected to the plunger 403, for example, by a plate. The diaphragm 409 and the housing 402 form a gas-tight pressure chamber 410. A pressure medium port 411 is provided on the housing 402 and enables the pressure chamber 410 to be charged with pressure or negative pressure by way of an external pressure medium supply or negative-pressure supply.

A spring may be arranged in the housing 402, though this is not shown. The spring may be supported between the housing 402 and the diaphragm 409 or the plunger 403 and may exert a force on the plunger so that a preload of the spring biases the plunger to assume a predefined position in the unpressurized state. A sensor also may be provided on the housing 402 to detect the position of the plunger 403.

A brake element 414 is provided and exerts a braking force on the plunger 403 with a corresponding braking action. The brake element 414 is a magnetorheological brake element and has a brake housing 415 with two opposite openings 416, 417 through which the plunger 403 is guided. The brake housing 415 is formed in two parts with two sub-housings 418, 419 that are connected to one another. One sub-housing 419 may be of pot-like form, and the other sub-housing 418 may be a cover or plug. Seals 420 are arranged at each of the two openings 416, 417 for guiding and sealing the plunger 403.

The sub-housing 419 of the brake housing 415 is formed in one piece with the housing 402, for example by injection molding.

The plunger 403 has a flange-like piston 421 within the brake housing 415. Here, the flange of the piston 421 projects radially from the plunger 403 and is guided through the magnetorheological material 422 in the brake housing 415. An electromagnet 423 or a coil is arranged around the brake housing 415 and can generate a magnetic field in the region of the magnetorheological material 422. The flange of the piston 421 moves through the magnetorheological material 422 as the plunger 403 is moved in an axial or longitudinal direction. The plunger 403 can be displaced without a great amount of friction and thus without a great amount of resistance when no magnetic field is applied, because the magnetorheological material 422 can flow past the piston-like element 421. By contrast, the elements of the magnetorheological material 422 interlink and the material becomes stiff or more viscous if a magnetic field is applied. In this way, the movement of the plunger 403 of the piston 421 through the magnetorheological material 422 is inhibited or braked or even stopped depending on the magnetic field that is applied.

As in all embodiments of the actuator, the magnetorheological material 422 may be a dry magnetorheological powder or may be a magnetorheological fluid. This may be based, for example, on an oil or some other fluid, in which magnetic or magnetizable elements are embedded. Both types of magnetorheological material 422 have the characteristics that the material 422 is flowable and has a low viscosity in the non-magnetized state, whereas the material has a higher viscosity in a magnetized state when a magnetic field is applied. The reason for this is for example that the elements of the magnetorheological material 422 interlink and thus increase the viscosity.

The brake housing 415 of FIG. 18 is arranged adjacent to the housing 402 as viewed in the longitudinal direction of the plunger 403.

The flange of the piston 421 may have at least one recess through which the magnetorheological material 422 can flow so that the piston 421 can slide easily through the magnetorheological material 422. Alternatively or in addition, a gap may be provided between the flange of the piston 421 and the wall of the brake housing 415, through which the magnetorheological material 422 can flow when the plunger 403 moves.

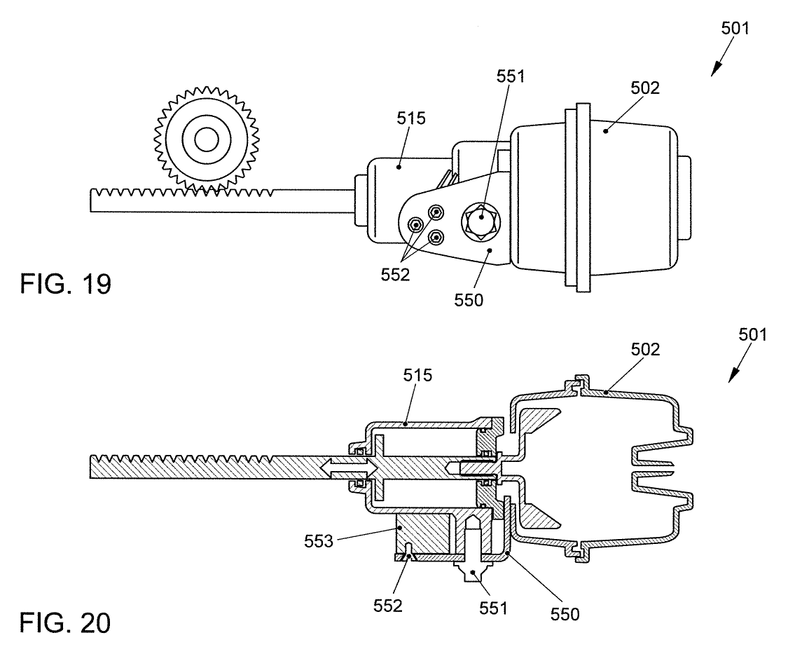

FIGS. 19 and 20 show a further embodiment of a drive element 501 that is similar to the drive element 401. However, the brake housing 515 is connected to the housing 502 not by injection molding but by a holding plate 550. The holding plate is connected to the housing 502 with both the brake housing 515 and the magnetic field-generating element 523 screwed to the holding plate 550. For this purpose, a first screw 551 is provided for the screw connection of the brake housing 515 to the holding plate 550, and second screws 552 are provided for the screw connection of the magnetic field-generating element 523 to the holding plate 550.

As an alternative to the illustrated embodiments with vacuum capsules, the drive element may be an electromotive drive element, such as an electric motor. The drive element may have an output element that may in be connected by a mechanism to the valve element to rotate the valve element.

The drive element also may be a hydraulic or pneumatic drive element, such as a hydraulic cylinder or vacuum capsule. The hydraulic or pneumatic drive element may have an output element connected by a mechanism to rotate the valve element.

The mechanism may be a lever arrangement, a toothed-rack mechanism or a toothed-wheel mechanism.

The brake element has, as magnetorheological brake element, a displaceable element that is displaced in the magnetorheological material. The displaceable element may be a type of piston or slide that is longitudinally displaceable in the chamber of the brake element, as shown in FIGS. 18 to 20.

It is also possible for the displaceable element to be a type of rotary piston or rotary slide that is received in rotationally displaceably in the chamber. A displaceable element of said type is provided in the brake element of FIGS. 1 to 16.

A force store element, such as a spring, can be provided to act on the mechanism, on the drive element and/or on the valve element to cause a force to act in the direction of a predefined position of the valve element. It is thus possible to realize a failsafe function.

### LIST OF REFERENCE DESIGNATIONS

1 Rotary fluid regulator
2 Housing
3 Inlet opening
4 Inlet opening
5 Outlet opening
6 Connector element
7 Valve element
8 Fluid duct
9 End
10 Circumferential surface
11 Opening
12 Sealing element
13 Opening
14 Sealing bead
15 Sealing bead
16 Housing cover
17 Drive connection
18 Shaft
19 Drive element
20 Plunger
21 Brake element
100 Valve element
101 Circumferential wall
102 Opening
103 Fluid duct
104 Opening
105 Shank
106 Receiving element
110 Sealing element
120 Sealing ring
121 Fastening arm
122 Fastening opening
130 Opening
131 Fastening arm
133 Edge
200 Shaft
201 Plunger
202 Lever
203 Transverse web
210 Sealing ring
211 Brake housing
300 Rotary fluid regulator
301 Drive element
302 Toothed rack
303 Toothed wheel
304 Shaft
305 Brake element
401 Drive element
402 Housing
403 Plunger
404 Element
405 Element
406 End
407 End
408 Toothing
409 Diaphragm
410 Pressure chamber
411 Pressure medium port
414 Brake element
415 Brake housing
416 Opening
417 Opening
418 Sub-housing
419 Sub-housing
420 Seal
421 Piston-like element
422 Magnetorheological material
423 Electromagnet, coil
501 Drive element
502 Housing
515 Brake housing
523 Magnetic field-generating element
550 Holding plate
551 Screw
552 Screw

What is claimed is:

1. A rotary fluid regulator comprising: a housing with at least one inlet opening and at least one outlet opening; a valve element received rotatably in the housing and being hollow to form a fluid duct; a drive element configured for rotating the valve element and adjusting or blocking a fluidic connection between the at least one inlet opening and the at least one outlet opening; and a brake element for influencing or blocking movement of the valve element.

2. The rotary fluid regulator of claim 1, wherein the at least one outlet opening comprises at least first and second outlet openings, so that a fluid flow can be distributed to the first and/or the second outlet opening.

3. The rotary fluid regulator of claim 1, wherein the at least one inlet opening comprises at least first and second inlet openings so that a fluid flow can be fed to the first and/or the second inlet opening.

4. The rotary fluid regulator of claim 1, wherein the drive element is an electric motor, and has an output element connected by a mechanism to the valve element to rotate the valve element.

5. The rotary fluid regulator of claim 4, wherein the mechanism is a toothed-rack mechanism or a toothed-wheel mechanism.

6. The rotary fluid regulator of claim 4, further comprising a spring that acts on the mechanism, on the drive element or on the valve element to cause a force to be exerted in a direction of a predefined position of the valve element.

7. The rotary fluid regulator of claim 1, wherein the drive element is a hydraulic or pneumatic drive element, and has an output element connected by a mechanism to the valve element to rotate the drive element.

8. The rotary fluid regulator of claim 1, wherein the brake element is a magnetorheological brake element.

9. The rotary fluid regulator of claim 8, wherein the magnetorheological brake element has an element displaceably received in a chamber, a magnetorheological material being in the chamber and being configured so that in a magnetized state, the magnetorheological material inhibits the displacement of the displaceable element in the chamber and, in a non-magnetized state, the magnetorheological material substantially does not inhibit the displacement of the displaceable element.

10. The rotary fluid regulator of claim 9, wherein the displaceable element is a piston or slide that is longitudinally displaceable in the chamber.

11. The rotary fluid regulator of claim 9, wherein the displaceable element is a rotary piston or rotary slide that is rotationally displaceable in the chamber.
